(19) United States
(12) Patent Application Publication
(10) Pub. No.: US 2015/0333349 A1
(43) Pub. Date: Nov. 19, 2015

(54) FUEL CELL SYSTEM AND POWER GENERATION PERFORMANCE RECOVERY METHOD OF A FUEL CELL IN A FUEL CELL SYSTEM

(71) Applicant: TOYOTA JIDOSHA KABUSHIKI KAISHA, Aichi (JP)

(72) Inventors: Yoshifumi HIRAO, Suntou-gun, Shizuoka-ken (JP); Masaaki MATSUSUE, Mishima-shi, Shizuoka-ken (JP); Tsuyoshi MARUO, Toyohashi-shi, Aichi-ken (JP)

(73) Assignee: TOYOTA JIDOSHA KABUSHIKI KAISHA, Toyota-shi, Aichi-ken (JP)

(21) Appl. No.: 14/654,960

(22) PCT Filed: Sep. 4, 2013
(86) PCT No.: PCT/JP2013/005236

§ 371 Date: Jun. 23, 2015

(30) Foreign Application Priority Data
Dec. 26, 2012 (JP) 2012-282053

(51) Int. Cl. H01M 8/04

(52) U.S. Cl. CPC H01M 8/04753; H01M 8/0432; H01M 8/04552; H01M 8/04291

(57) ABSTRACT

To recovers the power generation performance of a fuel cell system, a power generation performance recovery method of the fuel cell system comprises: stopping supply of an oxidant gas to the fuel cell; and after a voltage generated by the fuel cell is decreased to or below a predetermined first value and when temperature of the fuel cell is decreased to or below a predetermined second value, restarting the supply of the oxidant gas to the fuel cell and thereby restarting power generation of the fuel cell, so as to produce water and thereby recover voltage of the fuel cell.

### TECHNICAL FIELD

The present invention relates to a fuel cell system and more specifically a technique of recovering power generation performance in a fuel cell system.

### BACKGROUND ART

A known configuration of a fuel cell includes catalyst activity recovery means to supply a large electric current to the fuel cell and increase the amount of water produced from a catalyst layer to be equal to or greater than a predetermined amount, so as to recover the catalyst activity of an electrode catalyst in an electrode catalyst layer (Patent Literature 1).

### CITATION LIST

### Patent Literature

[PTL1] JP2008-77911 A

### SUMMARY OF INVENTION

### Technical Problem

This fuel cell supplies a large electric current for recovery of the catalyst activity and accordingly consumes a large amount of fuel. It has been found that when impurities such as sulfate ion (SO₄²⁻) and hydrosulfate ion (HSO₄¹⁻) produced from impurities in the air or produced by degradation of an ionomer in the catalyst layer adhere to the electrode catalyst, such impurities are not sufficiently removable by only the water discharged from the catalyst layer. In the description below, the sulfate ion and the hydrosulfate ion are collectively referred to as “sulfate ion or the like”.

### Solution to Problem

In order to achieve at least part of the foregoing, the present invention provides various aspects described below.

(1) According to one aspect of the invention, there is provided a fuel cell system. This fuel cell system comprises: a fuel cell having a catalyst; a fuel gas supplier configured to supply a fuel gas to the fuel cell; an oxidant gas supplier configured to supply an oxidant gas to the fuel cell; and a controller configured to control supply and stop of the fuel gas, supply and stop of the oxidant gas and power generation of the fuel cell, wherein the controller stops the supply of the oxidant gas to the fuel cell, and after a voltage generated by the fuel cell is decreased to or below a predetermined first value and also temperature of the fuel cell is decreased to or below a predetermined second value, the controller restarts the supply of the oxidant gas to the fuel cell and restarts power generation of the fuel cell, so as to produce water and thereby recover voltage of the fuel cell. In the fuel cell system of this aspect, decreasing the voltage generated by the fuel cell to or below the first value causes impurities to be released from a catalyst. Restarting power generation of the fuel cell at the temperature of not higher than the second value produces a large amount of liquid water. The impurities released from the catalyst are discharged out of a fuel cell stack by using the large amount of liquid water. This accordingly recovers the power generation performance of the fuel cell system.

(2) The fuel cell system according to the aspect before, wherein the first value may be a positive value that is not higher than 0.6 V. In the fuel cell system of this aspect, the voltage generated by the fuel cell is higher than 0 V but is not higher than 0.6 V. This is more likely to release the impurities from the catalyst.

(3) The fuel cell system according to the aspect before, wherein the controller may restart the power generation of the fuel cell such that an amount of water produced by reaction of the fuel cell after the restart of the power generation of the fuel cell is an amount corresponding to a relative humidity of not lower than 200% in a center of an oxidant gas flow path, in which the oxidant gas of the fuel cell flows, in a distribution of the amount of produced water in the fuel cell. In the fuel cell system of this aspect, the produced water corresponding to the relative humidity of not lower than 200% forms a large amount of liquid water by dew condensation. This enables the impurities to be flowed out by using the large amount of liquid water.

(4) The fuel cell system according to the aspect before, wherein a time when the voltage is maintained at or below the first value may continue for 10 minutes or longer. In the fuel cell system of this aspect, the time when the voltage is maintained at or below the first value continues for 10 minutes or longer. This extends the time when the impurities are released from the catalyst and thereby more effectively recovers the power generation performance of the fuel cell system.

(5) The fuel cell system according to the aspect before, wherein the second value may be a value that is not lower than room temperature and not higher than 40° C. The relative humidity increases with a decrease in temperature. The fuel cell system of this aspect controls the relative humidity to be not lower than 200% and thereby facilitates dew condensation by the combination of an increase in relative humidity with a decrease in temperature and an increase in humidity by the produced water.

(6) The fuel cell system according to the aspect before, wherein the controller may restart the power generation of the fuel cell with an electric current having a current density of not lower than 0.1 A/cm² and not higher than 0.2 A/cm². The fuel cell system of this aspect restarts power generation of the fuel cell with electric current having the current density of not higher than 0.2 A/cm². This improves the fuel consumption.

(7) The fuel cell system according to the aspect before, further may comprise a back pressure regulator configured to regulate back pressure of the oxidant gas at an outlet of the fuel cell, wherein the controller controls the back pressure to be not lower than 140 kPa (abs) and not higher than 200 kPa (abs) when restarting the power generation. The fuel cell system of this aspect controls the back pressure to be not lower than 140 kPa (abs) when restarting power generation. This accordingly controls the relative humidity to be not lower than 200% and thereby facilitates dew condensation. The fuel cell system of this aspect also controls the back pressure to be not higher than 200 kPa (abs) when restarting power generation. The oxidant gas supplier is thus not required to supply a high pressure of the oxidant gas to the fuel cell.

(8) According to one aspect of the invention, there is provided a power generation performance recovery method of a fuel cell system. This power generation performance recovery method of a fuel cell system comprises: stopping supply of an oxidant gas to the fuel cell; and after a voltage generated by the fuel cell is decreased to or below a predetermined first value and also temperature of the fuel cell is decreased to or below a predetermined second value, restarting the supply of the oxidant gas to the fuel cell and restarting power generation of the fuel cell, so as to produce water and thereby recover voltage of the fuel cell. In the power generation performance recovery method of this aspect, decreasing the voltage generated by the fuel cell to or below the first value causes impurities to be released from a catalyst. Restarting power generation of the fuel cell at the temperature of not higher than the second value produces a large amount of liquid water. This causes the impurities to be flowed out by using the large amount of liquid water and thereby recovers the power generation performance of the fuel cell system.

The invention may be implemented by a variety of aspects other than the fuel cell system, for example, a power generation performance recovery method in the fuel cell system and a method of releasing impurity from a catalyst in a fuel cell.

### BRIEF DESCRIPTION OF DRAWINGS

FIG. 1 is a diagram illustrating the configuration of a fuel cell system according to an embodiment of the invention.

FIG. 2 is a diagram schematically illustrating the structure of the power generation unit.

FIG. 3 is a diagram illustrating one cycle of a voltage recovery simulation test of the fuel cell system.

FIG. 4 is a graph showing the results of IV characteristic evaluation.

FIG. 5 is a graph showing the relationship between the stop time and the cell voltage in the stopping condition simulation process.

FIG. 6 is a diagram illustrating the relationship between the stopping condition simulation time and the voltage recovery amount.

FIG. 7 is a graph showing a variation in cell voltage in the restart simulation evaluation process.

FIG. 8 is a graph showing the relationship between the potential of the oxidant electrode and the adsorption amount of the sulfate ion or the like to the Pt electrode.

FIG. 9 is diagrams schematically illustrating a discharge mechanism of the sulfate ion or the like according to this Example.

FIG. 10 is a graph showing the relationship between the current density in the restart simulation evaluation process and the recovery amount of voltage of the power generation unit of the fuel cell 10.

FIG. 11 is a graph showing the relationship between the back pressure of the oxidant electrode and the recovery amount of voltage in the restart simulation evaluation process.

FIG. 12 is a diagram illustrating the relationship between the back pressure of the oxidant and the area filled with liquid water.

FIG. 13 is a diagram illustrating the relationship between the temperature (cell temperature) of the power generation unit of the fuel cell and the relative humidity at the outlet of the power generation unit in the restart simulation evaluation process.

FIG. 14 is a diagram illustrating the relationship between the current density and the relative humidity at the outlet of the power generation unit in the restart simulation evaluation process.

FIG. 15 is a diagram illustrating the relationship between the stoichiometric ratio of the oxidant gas and the relative humidity at the outlet of the power generation unit in the restart simulation evaluation process.

FIG. 16 is a diagram illustrating the relationship between the back pressure of the oxidant gas and the relative humidity at the outlet of the power generation unit in the restart simulation evaluation process.

FIG. 17 is a control flowchart of voltage recovery of the power generation unit.

FIG. 18 is a graph illustrating the relationship between the time when the potential of the oxidant electrode is maintained at or below 0.6 V and the recovery amount of voltage according to Eighth Example.

FIG. 19 is a diagram schematically illustrating a configuration of maintaining the potential of the oxidant electrode at or below 0.6 V for a long time.

FIG. 20 is a control flowchart of voltage recovery of the power generation unit employable in Eighth Example.

### DESCRIPTION OF EMBODIMENT

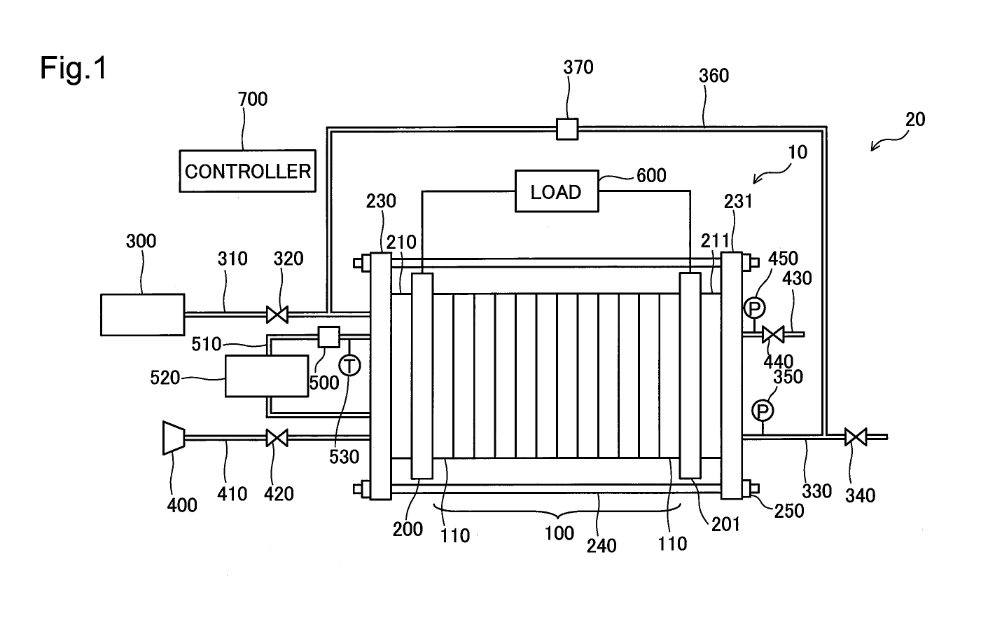

FIG. 1 is a diagram illustrating the configuration of a fuel cell system according to an embodiment of the invention. A fuel cell system 20 includes a fuel cell 10, a fuel tank 300, an air pump 400, a cooling water pump 500, a load 600 and a controller 700. The fuel cell 10 includes a fuel cell stack 100, current collectors 200 and 201, insulating plates 210 and 211, end plates 230 and 231, tension rods 240 and nuts 250.

The fuel cell stack 100 includes a plurality of power generation units 110. Each of the power generation units 110 is one unit cell. The power generation units 110 are stacked and connected in series to form the fuel cell stack 100 and generate a high voltage. The current collectors 200 and 201 are placed on the respective sides of the fuel cell stack 100 and are used to take the voltage and the electric current generated by the fuel cell stack 100 out of the fuel cell stack 100. The voltage and the electric current generated by the fuel cell stack 100 are supplied to the load 600. The load 600 includes auxiliary machinery such as a motor and an air conditioner of a fuel cell vehicle. The insulating plates 210 and 211 are placed further outside of the respective current collectors 200 and 201 to insulate the current collectors 200 and 201 from other members, for example, the end plates 230 and 231 or the tension rods 240 and suppress the flow of electric current therebetween. The end plates 230 and 231 are placed further outside of the respective insulating plates 210 and 211. The end plate 231 is located to be away from the end plate 230 by a predetermined distance by means of the tension rods 240 and the nuts 250.

The fuel tank 300 is connected with the fuel cell 10 by a fuel gas supply tube 310. The fuel gas supply tube 310 is equipped with a valve 320 configured to regulate the flow rate of a fuel gas. A fuel gas exhaust pipe 330 is connected to a downstream side of the fuel cell 10 and is equipped with a fuel gas exhaust valve 340 and a pressure gauge 350. The fuel gas exhaust valve 340 serves to regulate the back pressure of a fuel exhaust gas. The fuel gas exhaust pipe 330 is connected with the fuel gas supply pipe 310 by a fuel gas recovery pipe 360. The fuel gas recovery pipe 360 is equipped with a pump 370 provided to feed the fuel exhaust gas to the fuel gas supply pipe 310. The fuel gas used may be, for example, hydrogen gas.

The air pump 400 is connected with the fuel cell 10 by an oxidant gas supply tube 410. The oxidant gas supply tube 410 is equipped with a valve 420 configured to regulate the flow rate of an oxidant gas. An oxidant gas exhaust pipe 430 is connected to a downstream side of the fuel cell 10 and is equipped with an oxidant gas exhaust valve 440 and a pressure gauge 450. The oxidant gas exhaust valve 440 serves to regulate the back pressure of an oxidant exhaust gas. The oxidant gas used may be, for example, the air.

The cooling water pump 500 is connected with the fuel cell 10 by a cooling water pipe 510. The cooling water pipe 510 is equipped with a radiator 520 and a thermometer 530. The radiator 520 serves to cool down the cooling water discharged from the fuel cell 10. The thermometer 530 serves to measure the temperature of the cooling water discharged from the fuel cell 10.

The controller 700 controls opening and closing of the valves 320 and 420, the fuel gas exhaust valve 340 and the oxidant gas exhaust valve 440 and their opening positions, based on the amount of power generation by the fuel cell 10, the amount of power consumption by the load 600 and the temperature and the back pressure of the fuel cell 10, thereby controlling the operations of the fuel cell 10.

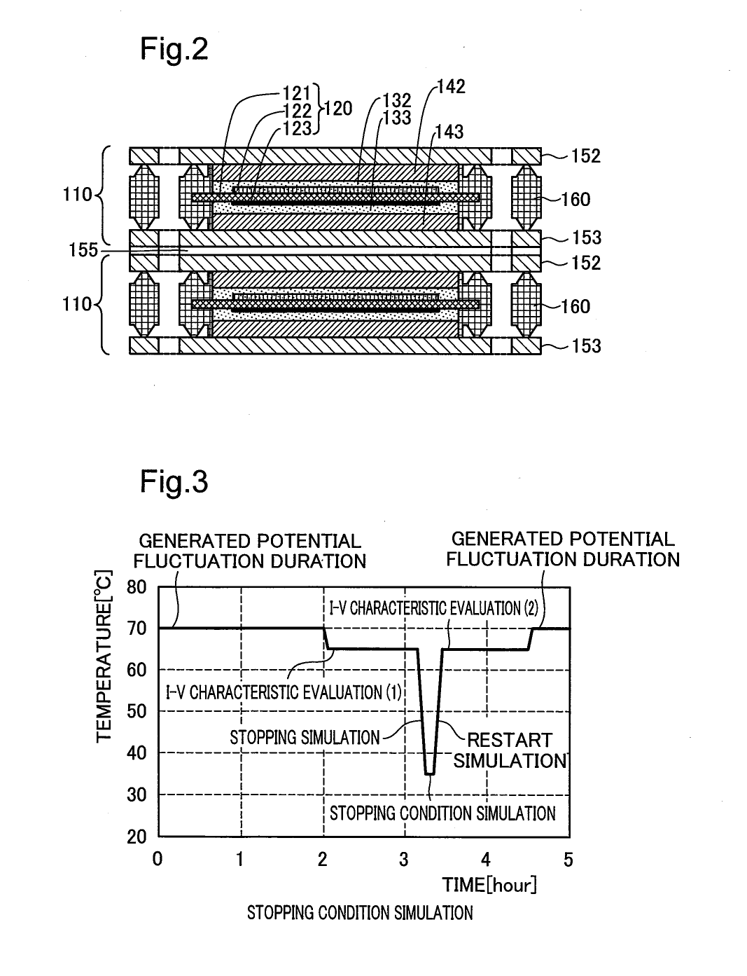

FIG. 2 is a diagram schematically illustrating the structure of the power generation unit 110. The power generation unit 110 includes a membrane electrode assembly 120, gas diffusion layers 132 and 133, porous gas flow paths 142 and 143, separator plates 152 and 153 and a seal gasket 160. The membrane electrode assembly 120 includes an electrolyte membrane 121 and catalyst layers 122 and 123. The catalyst layer 122 serves as a fuel electrode, and the catalyst layer 123 serves as an oxidant electrode. Accordingly, the catalyst layer 122 is also called anode catalyst layer 122 or fuel electrode 122, and the catalyst layer 123 is also called cathode catalyst layer 123 or oxidant electrode 123.

According to this embodiment, the power generation unit 110 is provided as a polymer electrolyte fuel cell. For example, a proton-conductive ion exchange membrane made of a fluororesin such as perfluorocarbon sulfonic acid polymer or a hydrocarbon resin may be used for the electrolyte membrane 121. The catalyst layers 122 and 123 are formed on the respective surfaces of the electrolyte membrane 121. According to this embodiment, the catalyst layers 122 and 123 are comprised of catalyst-supported particles (for example, carbon particles) with, for example, a platinum catalyst or a platinum alloy catalyst of platinum and another metal supported thereon and an electrolyte (ionomer). This embodiment uses Nafion (registered trademark) manufactured by du Pont as perfluorocarbon sulfonic acid polymer and the ionomer.

The gas diffusion layers 132 and 133 are respectively placed on the outer surfaces of the catalyst layers 122 and 123. According to this embodiment, carbon cloth of carbon unwoven fabric or carbon paper may be used for the gas diffusion layers 132 and 133. The porous gas flow paths 142 and 143 are respectively placed on the outer surfaces of the gas diffusion layers 132 and 133. The separator plates 152 and 153 are respectively placed on the outer surfaces of the porous gas flow paths 142 and 143. A cooling water flow path 155 is formed between the separator plate 152 of one power generation unit 110 and the separator plate 153 of an adjacent power generation unit 110. The seal gasket 160 is formed to surround the outer periphery of the membrane electrode assembly 120, the gas diffusion layers 132 and 133 and the porous gas flow paths 142 and 143. The seal gasket 160 is integrally molded with the membrane electrode assembly 120 by, for example, injection molding. Subsequently, the gas diffusion layers 132 and 133 and the porous gas flow paths 142 and 143 are sequentially placed on the respective surfaces of the membrane electrode assembly 120.

As described above with reference to FIG. 1, the fuel cell system 20 of the embodiment uses the air as the oxidant gas and the perfluorocarbon sulfonic acid polymer as the electrolyte and as the ionomer. In this fuel cell system, it is known that the electrolyte is chemically degraded to produce sulfate ion or hydrosulfate ion (hereinafter referred to as sulfate ion or the like) with progress in power generation. It is also known that the sulfate ion or the like is strongly adsorbed to the surface of the catalyst especially in the oxidant electrode (cathode electrode) to interfere with the electrode reaction of Equation (1) given below and deteriorate the power generation performance of the fuel cell 10.

O₂+4H++4e⁻→2H₂O (1)

### First Example

FIG. 3 is a diagram illustrating one cycle of a voltage recovery simulation test of the fuel cell system. One cycle of the voltage recovery simulation test includes a generated potential fluctuation duration process, an IV characteristic evaluation process (1), a stopping simulation evaluation process, a stopping condition simulation evaluation process, a restart simulation evaluation process and an IV characteristic evaluation process (2). The IV characteristic evaluation process (2) is followed by a generated potential fluctuation duration process of a next cycle.

In the voltage recovery simulation test, the controller 700 first performed the generated potential fluctuation duration process. In this process, the controller 700 supplied hydrogen to the fuel electrode 122 of the fuel cell 10 and supplied the air to the oxidant electrode 123. In this state, the controller 700 set the temperature of the fuel cell 10 to 70° C. and alternately performed power generation of a first cycle with setting voltage of the oxidant electrode 123 relative to the fuel electrode 122 (hereinafter referred to as “cell voltage”) to 0.9 V in the power generation unit 110 of the fuel cell 10 and power generation of a second cycle with setting the cell voltage to 0.6 V. Such alternate voltage fluctuation between two voltages is called rectangular wave potential fluctuation.

In the subsequent IV characteristic evaluation process (1), the controller 700 set the temperature of the fuel cell 10 to 65° C. and measured the voltage of the oxidant electrode 123 relative to the fuel electrode 122 of the power generation unit 110 by drawing a predetermined amount of electric current from the power generation unit 110 of the fuel cell 10. The controller 700 gradually decreased the electric current drawn from the power generation unit 110 of the fuel cell 10 from 2.4 A/cm² toward 0 A/cm².

In the subsequent stopping simulation evaluation process, the controller 700 decreased the temperature of the fuel cell 10 from 65° C. to 35° C. over 10 minutes, while continuing power generation of the fuel cell 10 at the electric current of 0.05 A/cm².

In the stopping condition simulation process, the controller 700 stopped the supply of the air at 35° C. as the temperature of the fuel cell 10 and stopped the supply of hydrogen subsequent to the stop of the supply of the air. The controller 700 stopped the supply of hydrogen subsequent to the stop of the supply of the air according to this Example, but may alternatively not stop but continue the supply of hydrogen even after the stop of the supply of the air. The controller 700 then maintained the temperature of the fuel cell 10 at 35° C.

In the restart simulation evaluation process, the controller 700 supplied hydrogen to the fuel electrode 122 of the fuel cell 10 and supplied the dry air to the oxidant electrode 123 to restart power generation. The controller 700 set the electric current drawn from the power generation unit 110 of the fuel cell 10 to 0.2 A/cm² and increased the temperature of the fuel cell 10 from 35° C. to 60° C. over 5 minutes.

In the subsequent IV characteristic evaluation process (2), like the IV characteristic evaluation process (1), the controller 700 set the temperature of the fuel cell 10 to 65° C. and measured the voltage of the fuel cell 10 by drawing a predetermined amount of electric current from the power generation unit 110 of the fuel cell 10. Like the IV characteristic evaluation process (1), the controller 700 gradually decreased the electric current drawn from the power generation unit 110 of the fuel cell 10 from 2.4 A/cm² toward 0 A/cm².

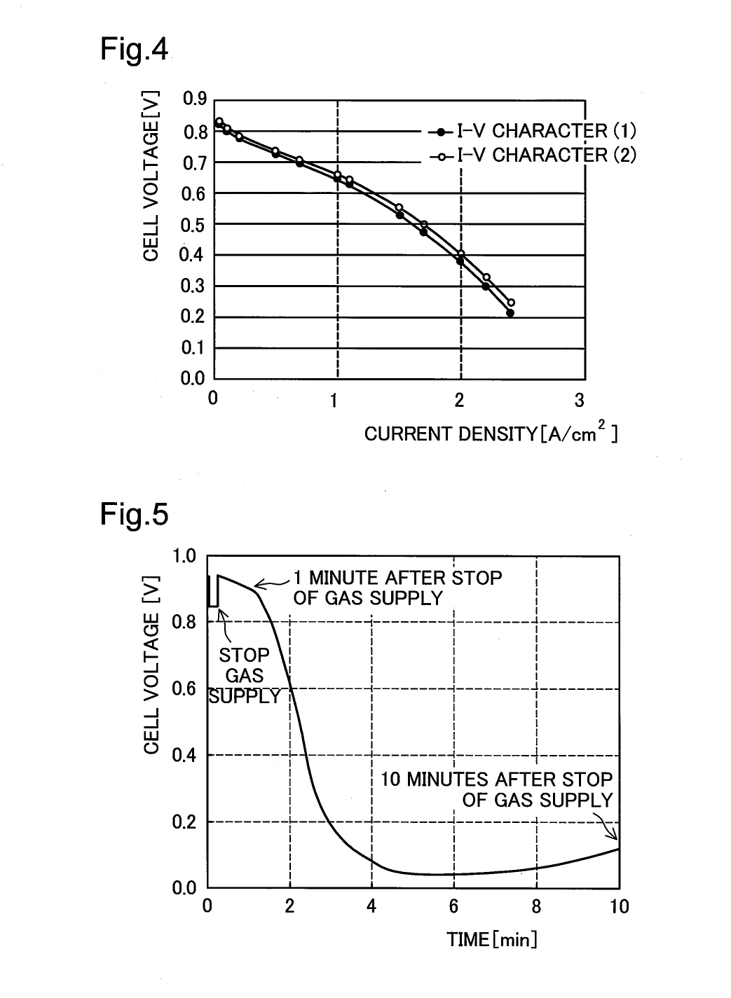

FIG. 4 is a graph showing the results of IV characteristic evaluation. The graph has the electric current drawn from the power generation unit 110 of the fuel cell 10 as abscissa and the cell voltage of the fuel cell 10 as ordinate. Since hydrogen is supplied to the fuel electrode, the cell voltage is equal to the oxidant electrode potential vs. RHE. RHE (reversible hydrogen electrode) denotes a hydrogen electrode using an electrolytic solution of the same pH as the pH of a solution in which a target electrode to be measured is placed. In general, the potential of the hydrogen electrode varies with a change in activity of hydrogen ion aH⁺ (i.e., pH) of the electrolytic solution. Accordingly, the electrode potential of a reversible hydrogen electrode (RHE) is not equal to the electrode potential of a standard hydrogen electrode (SHE). The reversible hydrogen electrode, however, allows for the use of the same electrolyte as that used for a target catalyst layer to be measured and thus advantageously has no need to consider a potential difference between two solutions. The cell potential denotes a potential of the oxidant electrode 123 relative to the fuel electrode 122. Employing a reversible hydrogen electrode for the fuel electrode 122 of the fuel cell is thus convenient for experiments.

As described above, the controller 700 gradually decreased the electric current drawn from the power generation unit 110 of the fuel cell 10 from 2.4 A/cm² toward 0 A/cm². As clearly understood from comparison between the graph of the IV characteristic evaluation process (1) and the graph of the IV characteristic evaluation process (2), the cell voltage in the IV characteristic evaluation process (2) is higher by 5 to 20 mV than the cell voltage in the IV characteristic evaluation process (1). The higher cell voltage in the IV characteristic evaluation process (2) than the cell voltage in the IV characteristic evaluation process (1) indicates recovery of the cell voltage. More specifically, the difference between the cell voltage in the IV characteristic evaluation process (2) and the cell voltage in the IV characteristic evaluation process (1) is not recovered by simply decreasing the potential of the oxidant electrode 123 to a low potential but is recovered through the stopping simulation evaluation process, the stopping condition simulation process and the restart simulation evaluation process. Decreasing the potential of the oxidant electrode 123 to or below 0.3 V vs. RHE removes an oxide film of the oxidant electrode 123. In both the IV characteristic evaluation processes (1) and (2), when the amount of electric current drawn from the power generation unit 110 of the fuel cell 10 is not lower than 2.2 A/cm², the cell voltage decreases to or below 0.3 V and is likely to remove the oxide film of the oxidant electrode 123. A reversible (recoverable) voltage drop in the IV characteristic evaluation process (1) may thus be attributed to a cause other than the oxide film of the oxidant electrode 123.

FIG. 5 is a graph showing the relationship between the stop time and the cell voltage in the stopping condition simulation process. The graph has the stop time as abscissa and the cell voltage of the power generation unit 111 as ordinate. In the stopping condition simulation process, the cell voltage decreases with consumption of oxygen in the air by cross leakage of hydrogen. An abrupt increase of the graph immediately after supply of the oxidant gas (the air) is attributed to an increase in cell voltage to OCV (open circuit voltage) by stopping the supply of the oxidant gas. At the stop time of 1 minute, oxygen still remains and the cell voltage decreases to only about 0.8 V. With subsequent consumption of oxygen, the cell voltage decreases over 3 to 4 minutes. After elapse of the stop time of 5 minutes, the cell voltage slightly increases. This increase may be attributed to that oxygen remaining in, for example, piping outside of the oxidant electrode 123 has moved to the oxidant electrode 123.

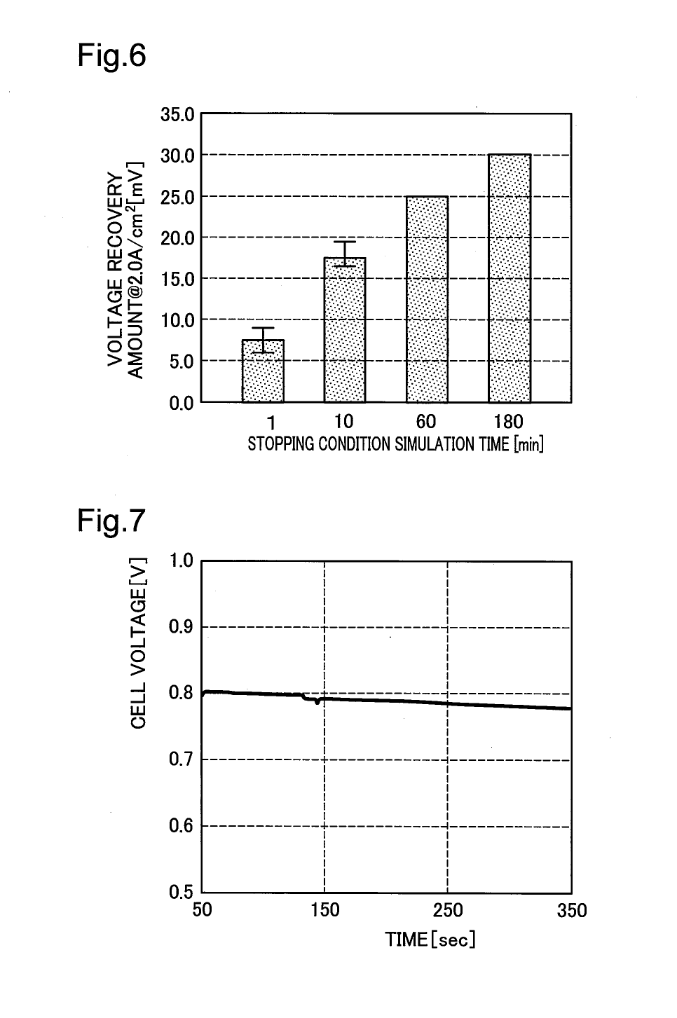

FIG. 6 is a diagram illustrating the relationship between the stopping condition simulation time and the voltage recovery amount. According to this Example, a voltage recovery amount V3 is calculated by Equation (2) given below. V1 represents a generated voltage at the electric current of 2.0 A/cm² drawn in the IV characteristic evaluation process (1). This generated voltage is a value after IR correction. IR correction herein denotes correction to eliminate the influence of an internal resistance of the power generation unit 110. V2 represents a generated voltage at the electric current of 2.0 A/cm² drawn in the IV characteristic evaluation process (2).

V3=V2−V1 (2)

As clearly understood from FIG. 6, the recovery amount of cell voltage was not so large to be 7.5 mV on average at the stop time of 1 minute in the stopping condition simulation process. At the stop time of 10 minutes in the stopping condition simulation process, the recovery amount of cell voltage was increased by about 10 mV from the value at the stop time of 1 minute and was 17.5 mV on average. When the stop time was extended to 60 minutes or to 180 minutes, the recovery amount of cell voltage was increased to about 25 mV or to about 30 mV. The recovery amount of cell voltage increases with an increase in stop time. By additionally taking into account the results of FIG. 5, the recovery amount of cell voltage increases with an increase of the time period when the cell voltage is maintained at or below 0.2 V.

FIG. 7 is a graph showing a variation in cell voltage in the restart simulation evaluation process. The graph has the elapsed time in the restart simulation evaluation process as abscissa and the cell voltage of the power generation unit 110 as ordinate. In the restart simulation evaluation process, the controller 700 set the stoichiometric ratio of the oxidant electrode 123 to 1.5, the back pressure of the oxidant electrode 123 to 140 kPa (abs), the inlet pressure of the oxidant electrode 123 to 150 kPa (abs) (back pressure+10 kPa (abs)) and the electric current drawn from the power generation unit 110 of the fuel cell 10 to 0.2 A/cm². The stoichiometric ratio herein denotes a value obtained by dividing an actual supply amount of a reactive gas (fuel gas or oxidant gas) by a theoretical amount of the reactive gas required for power generation. The cell voltage was about 0.8 V immediately after the beginning of the restart simulation evaluation process, was slightly decreased with elapse of time and was decreased to about 0.78 V after elapse of 350 seconds. The cell voltage was, however, not significantly decreased from 0.8 V.

FIGS. 6 and 7 provide the following results. The result at the stop time of 1 minute in the stopping condition simulation process is obtained when the controller 700 sets the voltage of the oxidant electrode 123 to 0.8 V (voltage at the stop time of 1 minute in FIG. 5) and subsequently sets the cell voltage to about 0.8 V and the electric current drawn from the power generation unit 110 of the fuel cell 10 to 0.2 A/cm² to perform power generation with a large amount of produced water (water flow). The result at the stop time of 10 minutes in the stopping condition simulation process is, on the other hand, obtained when the controller 700 sets the voltage of the oxidant electrode 123 to 0.1 V (voltage at the stop time of 10 minute in FIG. 5) and subsequently sets the cell voltage to about 0.8 V and the electric current drawn from the power generation unit 110 of the fuel cell 10 to 0.2 A/cm² to perform power generation with a large amount of produced water (water flow). By taking into account these two results, the cell voltage of the power generation unit 110 is not sufficiently recovered by only setting the voltage of the oxidant electrode 123 to a high voltage (0.8 V) and performing power generation with a large amount of water flow. The process of decreasing the voltage of the oxidant electrode 123 to a low voltage immediately before setting the voltage of the oxidant electrode 123 to a high voltage (0.8 V) and performing power generation with a large amount of water, however, enables the cell voltage to be recovered quickly in the IV-characteristic of the power generation unit 110.

It is known that, in the generated potential fluctuation duration process that simulates the ordinary operation of the fuel cell, a perfluorocarbon sulfonic acid polymer (for example, Nafion (registered trademark)) used for the electrolyte membrane 121 or a Nafion-based ionomer used for the electrolyte of the fuel electrode 122 and the oxidant electrode 123 is chemically degraded to produce sulfate ion or hydrosulfate ion (sulfate ion or the like). It is also known that the sulfate ion or the like is adsorbed to and poisons platinum (Pt) used for the oxidant electrode 123 and deteriorates the power generation performance of the fuel cell. The applicant of the present application has assumed that deterioration of the power generation performance of the fuel cell after the generated potential fluctuation duration process is attributed to adsorption of the sulfate ion or the like to Pt and resulting poisoning of Pt by the sulfate ion or the like. After the generated potential fluctuation duration process, the applicant of the present invention performed a hydrogen/nitrogen purging operation that set the cell temperature of the fuel cell 10 to 70° C., supplied hydrogen gas having the dew-point temperature of 70° C. to the fuel electrode 122 at 1 NL/min and supplied nitrogen gas having the dew-point temperature of 70° C. to the oxidant electrode 123 at 2 NL/min. As a result, the sulfate ion or the like was detected in drainage water discharged from the oxidant electrode 123. This confirmed recovery of the cell voltage in the IV characteristic after the hydrogen/nitrogen purging operation.

As described above, the generated potential fluctuation duration process causes chemical degradation of the perfluorocarbon sulfonic acid polymer (for example, Nafion (registered trademark)) or the Nafion-based ionomer to produce the sulfate ion or the like. It is confirmed that the produced sulfate ion or the like is adsorbed to and poisons Pt of the oxidant electrode 123 to deteriorate the power generation performance of the fuel cell.

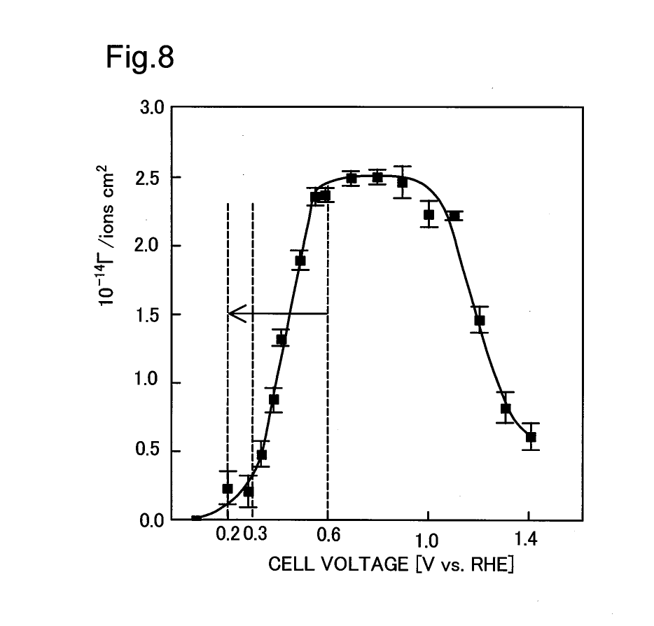

FIG. 8 is a graph showing the relationship between the potential of the oxidant electrode and the adsorption amount of the sulfate ion or the like to the Pt electrode. This graph is obtained by changing the scale of the abscissa of FIG. 6 in A. Kolics and A. Wieckowski, J. Phys. Chem. B 2001, 105, 2588-2595 from the silver/silver chloride electrode basis to the reversible hydrogen electrode basis (vs. RHE). As described above, the voltage value on the reversible hydrogen electrode basis is equal to the cell voltage that is the voltage value of the oxidant electrode relative to the fuel electrode 122. Accordingly, the abscissa may be expressed as cell voltage. As clearly understood from the graph, the adsorption amount of the sulfate ion or the like to Pt is decreased at the cell voltage of not lower than 0.0 V and not higher than 0.7 V. In other words, controlling the cell voltage to be not higher than 0.7 V enables the sulfate ion or the like to be released from the Pt electrode. The cell voltage is preferably not higher than 0.6V and is more preferably not higher than 0.3 V.

The process of decreasing the voltage of the oxidant electrode 123 to a low voltage causes the sulfate ion or the like to be released from the Pt electrode. Power generation with a large water flow is subsequently performed at the voltage of the oxidant electrode 123 increased to high voltage (0.8 V), so that a large amount of liquid water is produced. The sulfate ion or the like released from the Pt electrode is discharged from the oxidant electrode 123 by using the large amount of liquid water. This allows for recovery of the cell voltage of the power generation unit 110 of the fuel cell 10.

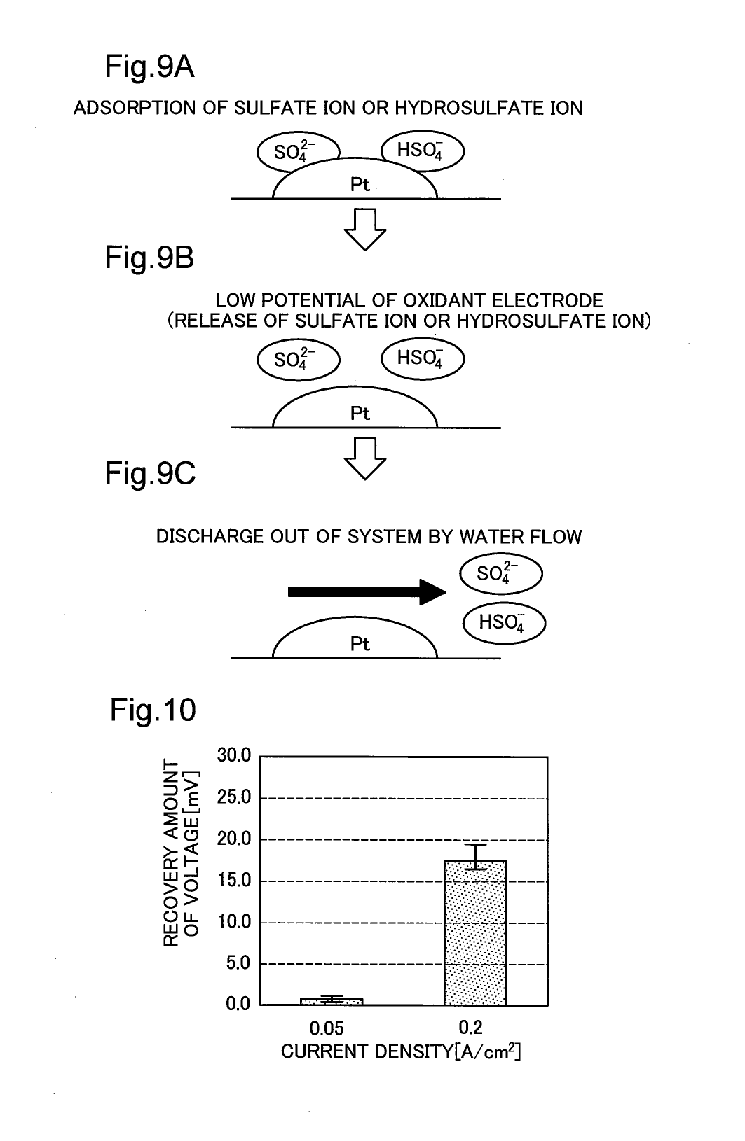

FIG. 9 is diagrams schematically illustrating a discharge mechanism of the sulfate ion or the like according to this Example. When the controller 700 performs the generated potential fluctuation duration process, the sulfate ion or the like is adsorbed to and poisons Pt as shown in a process (a), so as to decrease the cell voltage of the power generation unit 110 of the fuel cell 10 (FIG. 1). In a subsequent process (b), the controller 700 stops supply of the oxidant (the air) to the oxidant electrode 123. After elapse of two or more minutes since the stop of the supply of the oxidant, the cell voltage of the power generation unit 110 of the fuel cell 10 is decreased to or below 0.6 V as shown in FIG. 5. The cell voltage decreased to or below 0.6 V starts releasing the sulfate ion or the like from Pt as shown in FIG. 8. In a process (c), the controller 700 restarts the supply of the oxidant (the air) to the oxidant electrode 123 and performs power generation of the power generation unit 110 of the fuel cell 10 at the electric current of 0.2 A/cm² to produce a large amount of liquid water. The controller 700 discharges the free sulfate ion or the like by using the large amount of liquid water.

As described above, according to this Example, the controller 700 implements the process of decreasing the potential of the oxidant electrode 123 to or below 0.6 V by stopping the supply of the oxidant (the air) to the oxidant electrode 123. The controller 700 subsequently performs power generation of the power generation unit 110 of the fuel cell 10 at the electric current of 0.2 A/cm² to produce a large amount of liquid water. The controller 700 enables the free sulfate ion or the like to be discharged by using the large amount of liquid water.

### Second Example

FIG. 10 is a graph showing the relationship between the current density in the restart simulation evaluation process and the recovery amount of voltage of the power generation unit 110 of the fuel cell 10. Second Example made a comparison between the recovery amounts of voltage at the current density set to 0.2 A/cm² and at the current density set to 0.05 A/cm² in the restart simulation evaluation process. The parameters other than the current density used for power generation of the restart simulation evaluation process were the same as those of First Example. The recovery amount of voltage was about 0.05 mV on average at the current density of 0.05 A/cm² and was about 17.5 mV on average at the current density of 0.2 A/cm². The amount of produced water in the restart simulation evaluation process is proportional to the magnitude of the current density. An increase in current density in the restart simulation evaluation process increases the amount of power generation and increases the water flow. As a result, this increases the discharge rate of the sulfate ion or the like out of the system and decreases the adsorption amount of the sulfate ion or the like to the oxidant electrode 123, thus being more likely to recover the voltage of the power generation unit 110 of the fuel cell 10.

As described above, according to Second Example, the controller 700 allows for recovery of the voltage by drawing the electric current at the current density of 0.05 A/cm² to 0.2 A/cm². Increasing the current density in the restart simulation evaluation process is more likely to recover the voltage. The excessively high current density, however, causes poor fuel consumption. In terms of the fuel consumption, the controller 700 more preferably draws the electric current at the current density of 0.1 A/cm² to 0.2 A/cm².

### Third Example

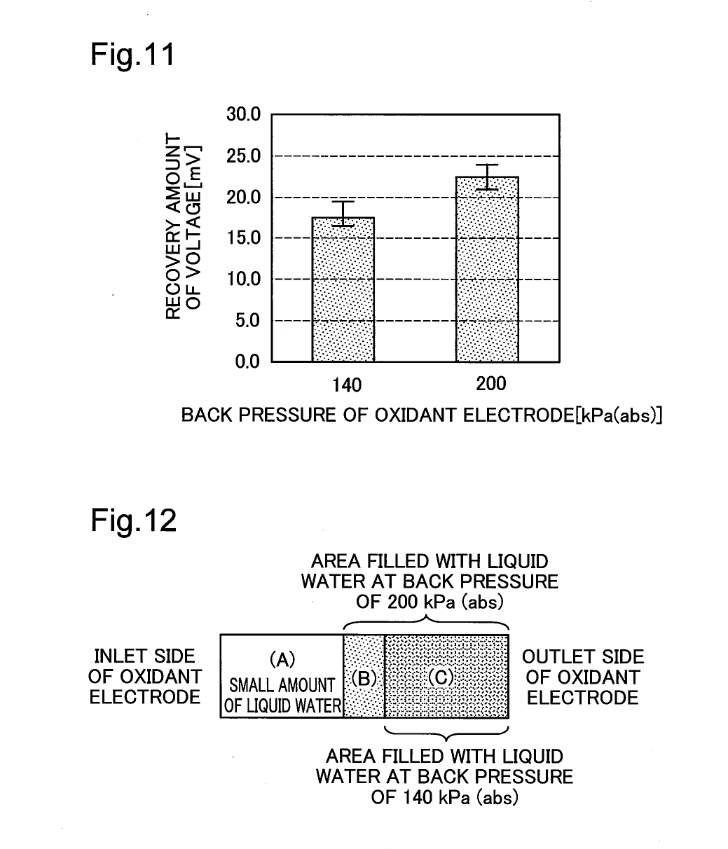

FIG. 11 is a graph showing the relationship between the back pressure of the oxidant electrode and the recovery amount of voltage in the restart simulation evaluation process. Third Example made a comparison between the recovery amounts of voltage at the back pressure of the air (oxidant gas) set to 140 kPa (abs) and the back pressure set to 200 kPa (abs) in the restart simulation evaluation process. In Third Example, the inlet pressure of the power generation unit 110 of the fuel cell 10 was set to the back pressure+10 kPa (abs). The parameters other than the back pressure and the inlet pressure used for power generation of the restart simulation evaluation process with supply of the oxidant gas in Third Example were the same as those of First Example. The recovery amount of voltage was 17.5 mV on average at the back pressure of 140 kPa (abs) and was 22.0 mV on average at the back pressure of 200 kPa (abs). This means that the higher back pressure provides the large recovery amount of voltage.

An increase in back pressure of the oxidant increases the internal pressure of the power generation unit 110 of the fuel cell 10, while decreasing the volume flow rate. This results in increasing the water vapor pressure and increasing the relative humidity at the outlet of the power generation unit 110. The higher back pressure extends the high pressure range and increases the area filled with produced water (liquid water).

FIG. 12 is a diagram illustrating the relationship between the back pressure of the oxidant and the area filled with liquid water. FIG. 12 schematically illustrates the power generation unit 110. The left side of FIG. 12 corresponds to the inlet side of the oxidant electrode 123, and the right side corresponds to the outlet side of the oxidant electrode 123. The water produced by power generation moves rightward from left with the flow of the oxidant gas. In a left side area (A) of FIG. 12, a small amount of water is produced by power generation. A right side area (C) of FIG. 12, on the other hand, has a large integration amount of liquid water flow by addition of large amounts of water vapor and produced water flowing from the left side area and a center area to an amount of water produced by power generation in the right side area. The integration amount of liquid water flow herein denotes an integration value of the amount of water produced in the upstream of a predetermined point. By considering the relationship between the pressure (internal pressure of the power generation unit 110) and the distribution of liquid water, the left side area (A) of FIG. 12 has high pressure but a small amount of produced water. The produced water is thus unlikely to form liquid water, so that the left side area (A) has a small amount of liquid water. The right side area (C) of FIG. 12, on the other hand, has pressure equivalent to the back pressure but a large amount of produced water. The produced water is thus likely to form liquid water, so that the right side area (C) has a large amount of liquid water. An increase of the higher back pressure to 200 kPa (abs) extends the high pressure range to the left side, so that produced water is likely to form liquid water in a center area (B) of FIG. 12. As a result, the area filled with liquid water is extended at the back pressure of 200 kPa (abs), compared with the area at the back pressure of 140 kPa (abs).

As described above, according to Third Example, the controller 700 controls the back pressure to 140 kPa (abs) to 200 kPa (abs), so as to fill the power generation unit 110 of the fuel cell 10 with liquid water and thereby increase the recovery amount of voltage. In order to increase the back pressure, the inlet pressure of the power generation unit 110 may be to be increased according to the magnitude of the back pressure. The output of the air pump 400 (FIG. 1) may be to be increased, in order to increase the inlet pressure of the power generation unit 110. As a result, this may increase the fuel consumption for driving the air pump 400 and may cause poor fuel consumption. The back pressure may thus be not higher than 200 kPa (abs).

### Fourth Example

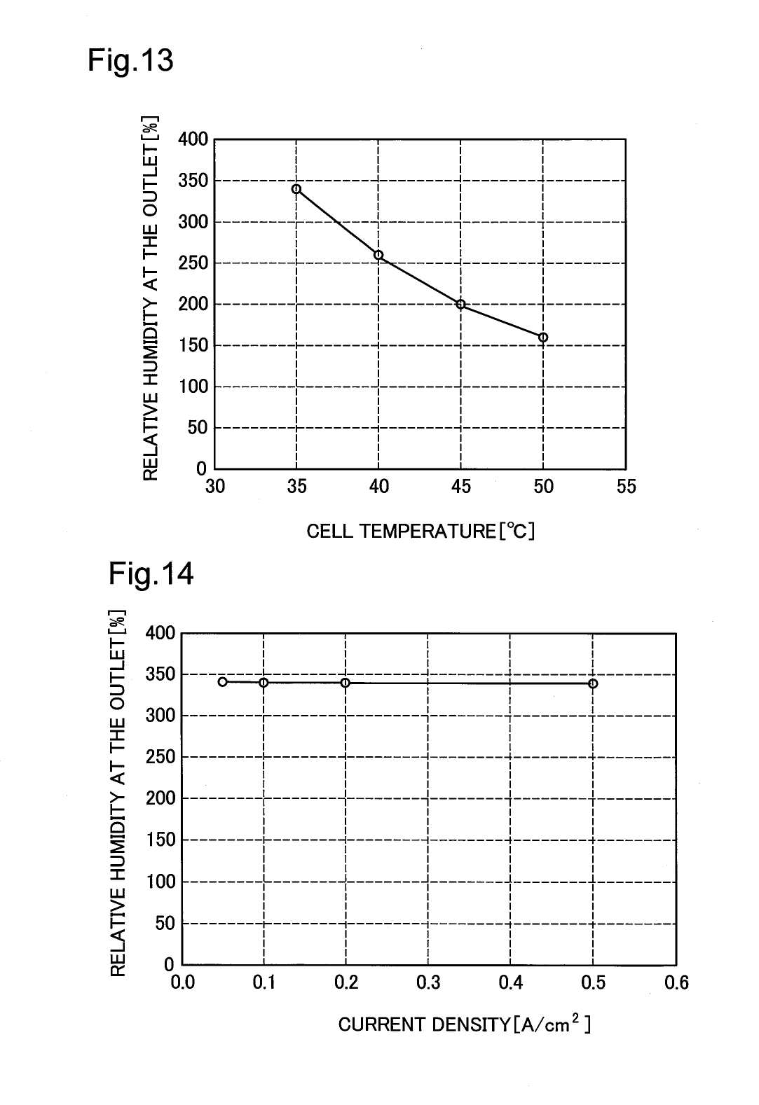

FIG. 13 is a diagram illustrating the relationship between the temperature (cell temperature) of the power generation unit 110 of the fuel cell 10 and the relative humidity at the outlet of the power generation unit 110 in the restart simulation evaluation process. The results of Fourth Example to Seventh Example are calculated values on the assumption of uniform in-plane power generation and no transfer of water between the anode and the cathode. The graph has the cell temperature as abscissa and the relative humidity at the outlet of the power generation unit 110 as ordinate. Fourth Example compared the relative humidity at the outlet of the power generation unit 110 with a variation in cell temperature. The conditions employed in Fourth Example were as follows: the stoichiometric ratio of the oxidant gas was 2.0; the back pressure of the oxidant gas was 100 kPa (abs); and the current density of electric current drawn from the power generation unit 110 of the fuel cell 10 was 0.2 A/cm² in the restart simulation evaluation process. The relative humidity at the outlet of the power generation unit 110 increased with a decrease in cell temperature. An increase in cell temperature increases the saturated water vapor pressure and thereby decreases the relative humidity (%) (=absolute water vapor pressure [Pa]/saturated water vapor pressure [Pa]×100). The absolute water vapor pressure is proportional to the integration amount of liquid water flow. The controller 700 decreases the cell temperature to increase the amount of liquid water and facilitate the outflow of the sulfate ion or the like, thus increasing the likelihood of recovery of the voltage of the power generation unit 110.

The cell temperature is not changed but is fixed over the inlet to the outlet of the power generation unit 110. When the amount of power generation per unit area is not changed but is identical at any position in the power generation unit 110, the amount of produced water per unit area is also not changed but is identical at any position in the power generation unit 110. At the cell temperature of 45° C., the relative humidity is 200% at the outlet of the power generation unit 110. The relative humidity is then 100% at the center of the power generation unit 110, so that a downstream area of the power generation unit 110 from its approximate center is filled with liquid water. At the cell temperature of 40° C., the relative humidity is 260% at the outlet of the power generation unit 110. In order to fill a downstream area of the power generation unit 110 from its approximate center with liquid water, the cell temperature should be not higher than 45° C. and is more preferably not higher than 40° C.

As described above, according to Fourth Example, the controller 700 controls the cell temperature in the restart simulation evaluation process to be not lower than room temperature (25° C.) and not higher than 45° C. to fill the downstream area of the power generation unit 110 from its approximate center with liquid water, increase the amount of liquid water and facilitate the outflow of the sulfate ion or the like, thus increasing the likelihood of recovery of the voltage of the power generation unit 110. The cell temperature may be not lower than 25° C. and not higher than 40° C. This further facilitates the power generation unit to be filled with liquid water.

### Fifth Example

FIG. 14 is a diagram illustrating the relationship between the current density and the relative humidity at the outlet of the power generation unit 110 in the restart simulation evaluation process. The graph has the current density of electric current drawn from the power generation unit 110 of the fuel cell 10 as abscissa and the relative humidity at the outlet of the power generation unit 110 as ordinate. The conditions employed in Fifth Example were as follows: the stoichiometric ratio of the oxidant gas was 2.0; the back pressure of the oxidant gas was 100 kPa (abs); and the current density of electric current drawn from the power generation unit 110 of the fuel cell 10 was 0.2 A/cm² in the restart simulation evaluation process. According to the results shown in FIG. 14, the relative humidity at the outlet of the power generation unit 110 has no significant change with a variation in current density in the restart simulation evaluation process. When the relative humidity at the outlet is equal to or higher than 200%, the current density may be in the range of 0.05 A/cm² to 0.5 A/cm² on the assumption of a sufficient water flow. An increase in current density increases the amount of power generation and increases the integration amount of liquid water flow. Accordingly, an increase in current density enables the free sulfate ion or the like to be discharged more quickly.

### Sixth Example

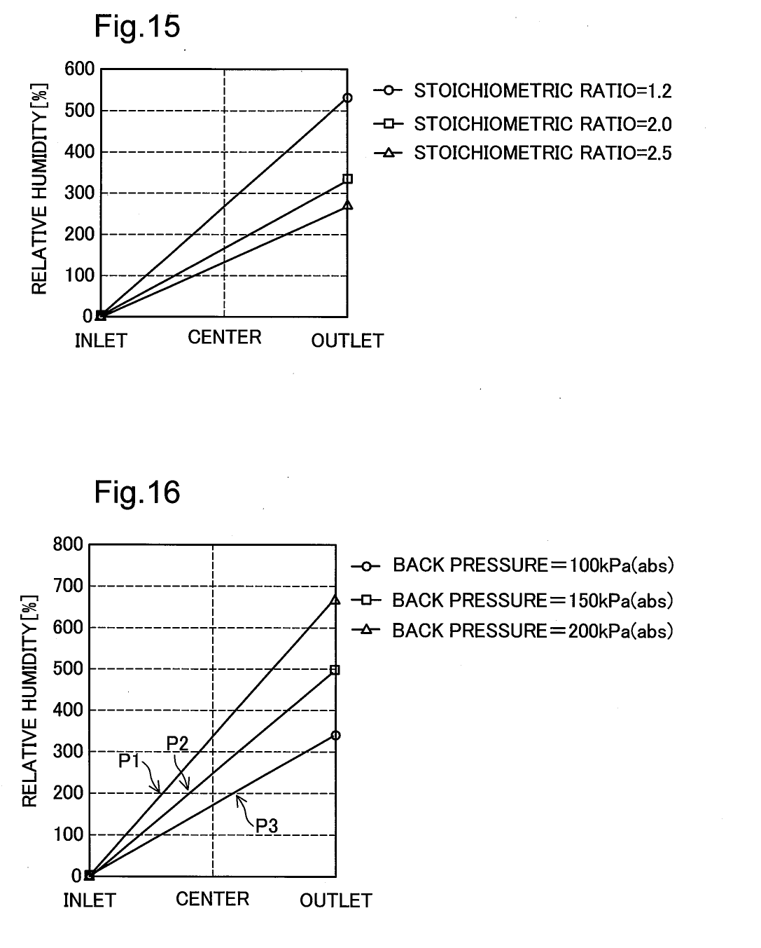

FIG. 15 is a diagram illustrating the relationship between the stoichiometric ratio of the oxidant gas and the relative humidity at the outlet of the power generation unit 110 in the restart simulation evaluation process. The abscissa of the graph shows the position in the power generation unit 110; the left end corresponds to the oxidant gas inlet in the power generation unit 110 and the right end corresponds to the oxidant gas outlet in the power generation unit 110. The ordinate of the graph shows the relative humidity. The conditions employed in Sixth Example were as follows: the cell temperature was 35° C.; the back pressure of the oxidant gas was 100 kPa (abs); and the current density of electric current drawn from the power generation unit 110 of the fuel cell 10 was 0.2 A/cm² in the restart simulation evaluation process. Sixth Example used the oxidant gas that had the dew point of −40° C. and was substantially free from the moisture content.

A decrease in stoichiometric ratio of the oxidant gas decreases the flow rate of dry oxidant gas and thereby increases the relative humidity at the outlet of the power generation unit 110. For example, on the assumption that the power generation unit 110 is filled with liquid water in an area having the relative humidity of or above 200%, an approximately 45% area on the downstream side is filled with liquid water at the stoichiometric ratio of 2.0, and an approximately 55% area on the downstream side is filled with liquid water at the stoichiometric ratio of 1.2. Accordingly, a decrease in stoichiometric ratio increases the area from which the sulfate ion or the like is dischargeable.

As described above, according to Sixth Example, the controller 700 increases the likelihood that the power generation unit 110 is filled with liquid water by decreasing the stoichiometric ratio of the oxidant gas in the restart simulation evaluation process.

### Seventh Example

FIG. 16 is a diagram illustrating the relationship between the back pressure of the oxidant gas and the relative humidity at the outlet of the power generation unit 110 in the restart simulation evaluation process. Like FIG. 15, the abscissa of the graph shows the position in the power generation unit 110; the left end corresponds to the oxidant gas inlet in the power generation unit 110 and the right end corresponds to the oxidant gas outlet in the power generation unit 110. The ordinate of the graph shows the relative humidity. The conditions employed in Seventh Example were as follows: the cell temperature was 35° C.; the stoichiometric ratio of the oxidant gas was 2.0; and the current density of electric current drawn from the power generation unit 110 of the fuel cell 10 was 0.2 A/cm² in the restart simulation evaluation process. Sixth Example used the oxidant gas that had the dew point of −40° C. and was substantially free from the moisture content.

An increase in back pressure of the oxidant gas decreases the flow rate of dry oxidant gas per area and thereby increases the relative humidity at the outlet of the power generation unit 110. For example, it is assumed that the power generation unit 110 is filled with liquid water in an area having the relative humidity of or above 200%. In FIG. 16, P1 is an intersection between a back pressure line of 200 kPa (abs) and a relative humidity line of 200%. At the back pressure of 200 kPa (abs), an area of the power generation unit 110 from the inlet to the point P1 (30% of the total area) has the relative humidity of lower than 200% and is thus not filled with liquid water, while an area from the point P1 to the outlet (70% of the total area) has the relative humidity of not lower than 200% and is thus filled with liquid water. Similarly, P2 is an intersection between a back pressure line of 150 kPa (abs) and the relative humidity line of 200%. At the back pressure of 150 kPa (abs), an area of the power generation unit 110 from the inlet to the point P2 (40% of the total area) is not filled with liquid water, while an area from the point P2 to the outlet (60% of the total area) is filled with liquid water. P3 is an intersection between a back pressure line of 100 kPa (abs) and the relative humidity line of 200%. At the back pressure of 100 kPa (abs), an area from the inlet to the point P3 (60% of the total area) is not filled with liquid water, while an area from the point P3 to the outlet (40% of the total area) is filled with liquid water. Based on these results, the back pressure is preferably in the range of 150 kPa (abs) to 200 kPa (abs). This Example has employed the assumption that the power generation unit 110 is filled with liquid water in the area having the relative humidity of or above 200%. At the relative humidity of not lower 100%, the water vapor exceeding the relative humidity of 100% causes dew condensation and forms liquid water. Accordingly, the assumption employed may be that the power generation unit 110 is filled with liquid water in an area having the relative humidity of any value in the range of not lower than 100% and lower than 200%.

As described above, according to Seventh Example, the controller 700 increases the likelihood that the power generation unit 110 is filled with liquid water by increasing the back pressure of the oxidant gas in the restart simulation evaluation process. This result well agrees with the result of Third Example that the back pressure is preferably in the range of 140 kPa (abs) to 200 kPa (abs). By further taking into account the result of this Example, the back pressure is more preferably in the range of 150 kPa (abs) to 200 kPa (abs).

### Control Flowchart of Voltage Recovery of Power Generation Unit 110

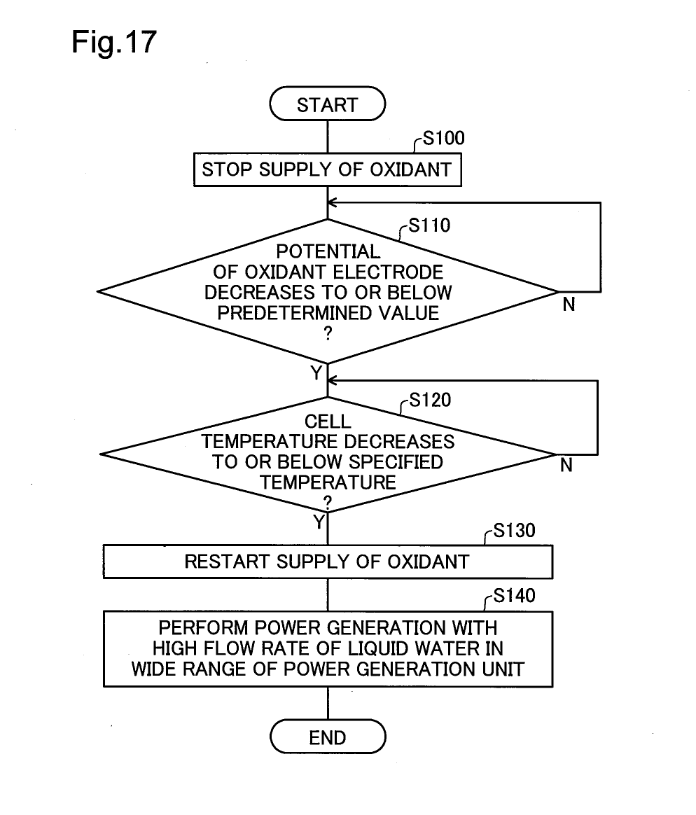

FIG. 17 is a control flowchart of voltage recovery of the power generation unit. At step S100, the controller 700 stops supply of the oxidant gas to the power generation unit 110. This decreases the cell voltage as shown in FIG. 5. The reaction of the fuel cell is an exothermic reaction, so that stopping the supply of the oxidant gas stops power generation and decreases the temperature of the power generation unit (cell temperature).

At step S110, the controller 700 determines whether the potential of the oxidant electrode 123 decreases to or below a predetermined value. The predetermined value may be, for example, 0.6 V as described above. This step implements the process of decreasing the voltage of the oxidant electrode 123 to a low voltage. At step S120, the controller 700 determines whether the temperature of the power generation unit 110 (cell) decreases to or below a specified temperature. The specified temperature may be, for example, 40° C. or 35° C. as described above. The controller 700 may change the sequence of determinations at step S110 and S120.

At step S130, the controller 700 restarts the supply of the oxidant gas to the power generation unit 110. At step S140, the controller 700 performs power generation with a high flow rate of liquid water in a wide range of the power generation unit 110. More specifically, the controller 700 performs power generation such that the integration amount of liquid water flow of the produced water becomes equal to a value corresponding to the relative humidity of 200% in a wide range of the power generation unit 110.

The control flowchart of voltage recovery of the power generation unit 110 described above implements the process of decreasing the voltage of the oxidant electrode 123 to a low voltage at step S110. The controller 700 is thus likely to release the sulfate ion or the like from Pt of the oxidant electrode 123. At step S140, the controller 700 produces a large amount of water and uses this produced water to flow out the free sulfate ion or the like, so as to recover the power generation performance of the power generation unit 110.

### Modifications in Control of Voltage Recovery of Power Generation Unit 110

(1) In the control flowchart shown in FIG. 17, the controller 700 may disconnect the load 600, before stopping the supply of the oxidant gas at step S100.

(2) The controller 700 may disconnect the load 600 between step S110 and S120.

(3) The controller 700 may connect a fixed resistance in place of the load 600 after disconnecting the load 600 in (1).

(4) The controller 700 may connect the fixed resistance in (3) after stopping the supply of the oxidant at step S100.

(5) The controller 700 may connect an external load instead of connecting the fixed resistance in (3).

(6) The controller 700 may connect the external load in (5) after stopping the supply of the oxidant at step S100, like (4).

(7) In the control flowchart shown in FIG. 17, the controller 700 may stop the recovery process when the cell temperature does not decrease to or below the specified temperature at step S120. In the case that step S120 is performed prior to step S110 in FIG. 17, the controller 700 may stop the recovery process when the cell temperature does not decrease to or below the specified temperature at step S120.

(8) At step S120 in the control flowchart shown in FIG. 17, the controller 700 may cool down the power generation unit 110 of the fuel cell 10 by natural cooling or by forced cooling. The controller 700 may use the cooling water pump 500 to supply a larger amount of cooling water and thereby forcibly cool down the power generation unit 110.

### Eighth Example

Eighth Example produced cathode catalyst ink by making a PtCo catalyst supported on carbon particles and adding Nafion (registered trademark), while producing anode catalyst ink by making a Pt catalyst supported on carbon particles and adding Nafion (registered trademark). The cathode catalyst layer 123 and the anode catalyst layer 122 were then formed by applying and drying the cathode catalyst ink and the anode catalyst ink on a substrate. The membrane electrode assembly MEA 120 (FIG. 2) was then produced by transferring the cathode catalyst layer and the anode catalyst layer to the electrolyte membrane 121 (Nafion-based electrolyte membrane) by thermal pressing. In Eighth Example, the area of the MEA 120 was not less than 200 cm². A module of the power generation unit 110 was then produced by placing the MEA 120 between the gas diffusion layers 132 and 133.

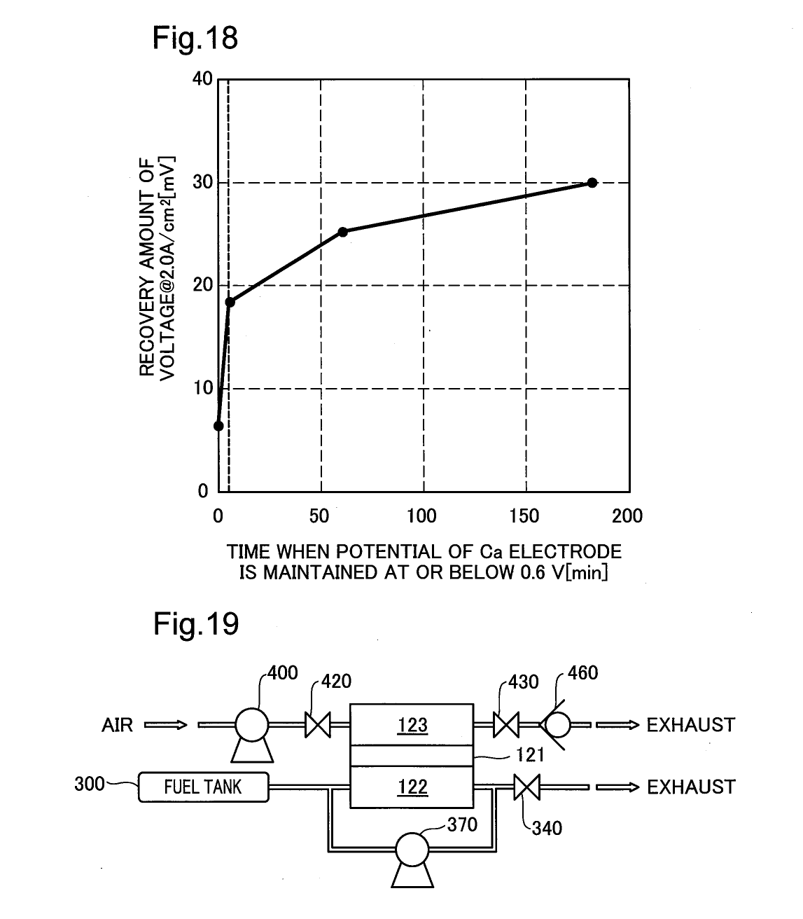

FIG. 18 is a graph illustrating the relationship between the time when the potential of the oxidant electrode is maintained at or below 0.6 V and the recovery amount of voltage according to Eighth Example. Like First Example, one cycle in Eighth Example includes a generated potential fluctuation duration process, an IV characteristic evaluation process (1), a stopping simulation evaluation process, a stopping condition simulation evaluation process, a restart simulation evaluation process and an IV characteristic evaluation process (2). Eighth Example measured the effect of the time when the potential of the oxidant electrode was maintained at a low potential in the stopping condition simulation evaluation process. When the time at which the potential of the oxide electrode was maintained at or below 0.6 V was equal to or longer than 10 minutes, the recovery amount of voltage was about 17.5 mV or more. The longer time when the low potential is maintained results in the larger recovery amount of voltage. As described above with reference to FIG. 8, controlling the cell voltage (potential of oxidant electrode) to or below 0.7 V enables the sulfate ion or the like to be released from the Pt electrode. An increase in this low potential-maintaining time allows for release of a greater amount of the sulfate ion or the like. In Eighth Example, the time when the potential of the oxidant electrode was maintained at or below 0.6 V was equal to or longer than 10 minutes. In order to achieve the recovery amount of voltage of approximately 10 mV, however, the time when the potential of the oxidant electrode is maintained at or below 0.6 V may be several minutes.

FIG. 19 is a diagram schematically illustrating a configuration of maintaining the potential of the oxidant electrode at or below 0.6 V for a long time. The illustration of FIG. 19 simplifies a configuration similar to FIG. 1. The difference of the configuration of FIG. 19 from the configuration of FIG. 1 is that a check valve 460 is additionally provided in the downstream of the oxidant gas exhaust valve 440. This suppresses the oxidant gas from flowing back from the downstream in the exhaust system and increasing the potential of the oxidant electrode.

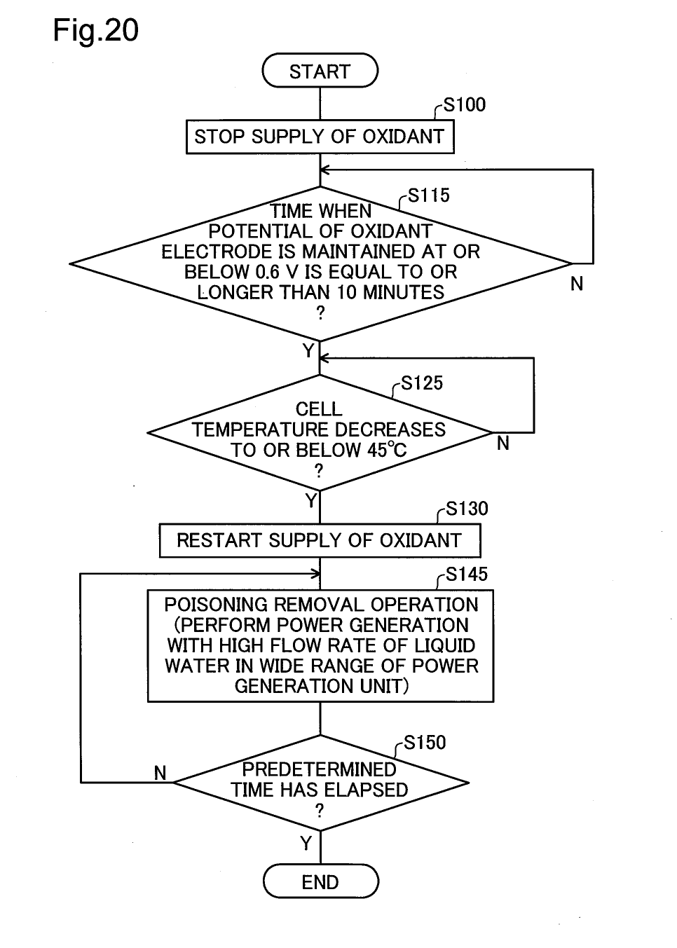

FIG. 20 is a control flowchart of voltage recovery of the power generation unit employable in Eighth Example. The following describes the differences from the control flowchart of voltage recovery shown in FIG. 17. The control process of FIG. 17 simply determines whether the potential of the oxidant electrode decreases to or below the predetermined value at step S110. The control process of FIG. 20, on the other hand, determines the low potential-maintaining time or more specifically determines whether the time when the potential of the oxidant electrode is maintained at or below 0.6 V (low potential-maintaining time) is equal to or longer than 10 minutes at step S115. Step S125 using 45° C. as the reference temperature is substantially equivalent to step S120 of FIG. 17. Step S145 is substantially equivalent to step S140 of FIG. 17.

As described above, according to Eighth Example, the time when the potential of the oxidant electrode is maintained at or below 0.6 V is set to be equal to or longer than 10 minutes. This allows for release of a larger amount of the sulfate ion or the like and increases the recovery amount of voltage of the power generation unit. The sequence of the determinations of step S115 and S125 may be changed in FIG. 20.

The foregoing describes some aspects of the invention with reference to some embodiments and examples. The embodiments and the examples of the invention described above are provided only for the purpose of facilitating the understanding of the invention and not for the purpose of limiting the invention in any sense. The invention may be changed, modified and altered without departing from the scope of the invention and includes equivalents thereof.

### REFERENCE SIGNS LIST

10 . . . fuel cell
20 . . . fuel cell system
100 . . . fuel cell stack
110 . . . power generation unit
120 . . . membrane electrode assembly
121 . . . electrolyte membrane
122 . . . anode catalyst layer, fuel electrode
123 . . . cathode catalyst layer, oxidant electrode
132, 133 . . . gas diffusion layer
142, 143 . . . porous gas flow path
152, 153 . . . separator plate
160 . . . seal gasket
200 . . . current collector
210 . . . insulating plate
230, 231 . . . end plate
240 . . . tension rod
250 . . . nut
300 . . . fuel tank
310 . . . fuel gas supply tube
320 . . . valve
330 . . . fuel gas exhaust pipe
340 . . . fuel gas exhaust valve
350 . . . pressure gauge
360 . . . fuel gas recovery pipe
370 . . . pump
400 . . . air pump
410 . . . oxidant gas supply tube
420 . . . valve
430 . . . oxidant gas exhaust pipe
440 . . . oxidant gas exhaust valve
450 . . . pressure gauge
460 . . . check valve
500 . . . cooling water pump
510 . . . cooling water pipe
520 . . . radiator
530 . . . thermometer
600 . . . load
700 . . . controller

1. A fuel cell system, comprising:
a fuel cell having a catalyst;
a fuel gas supplier configured to supply a fuel gas to the fuel cell;
an oxidant gas supplier configured to supply an oxidant gas to the fuel cell; and
a controller configured to control supply and stop of the fuel gas, supply and stop of the oxidant gas and power generation of the fuel cell, wherein
the controller stops the supply of the oxidant gas to the fuel cell, and after a voltage generated by the fuel cell is decreased to or below a predetermined first value and also temperature of the fuel cell is decreased to or below a predetermined second value, the controller restarts the supply of the oxidant gas to the fuel cell and restarts power generation of the fuel cell, so as to produce water and thereby recover voltage of the fuel cell.

2. The fuel cell system according to claim 1,
wherein the first value is a positive value that is not higher than 0.6 V.

3. The fuel cell system according to claim 1,
wherein the controller restarts the power generation of the fuel cell such that an amount of water produced by reaction of the fuel cell after the restart of the power generation of the fuel cell is an amount corresponding to a relative humidity of not lower than 200% in a center of an oxidant gas flow path, in which the oxidant gas of the fuel cell flows.

4. The fuel cell system according to claim 1,
wherein a time from the time when the voltage is decreased to or below a predetermined first value to the time when the controller restarts the supply of the oxidant gas is 10 minutes or longer.

5. The fuel cell system according to claim 1,
wherein the second value is a value that is not lower than room temperature and not higher than 40° C.

6. The fuel cell system according to claim 1,
wherein the controller restarts the power generation of the fuel cell with an electric current having a current density of not lower than 0.1 A/cm² and not higher than 0.2 A/cm².

7. The fuel cell system according to claim 1, further comprising:
a back pressure regulator configured to regulate back pressure of the oxidant gas at an outlet of the fuel cell, wherein
the controller controls the back pressure to be not lower than 140 kPa (abs) and not higher than 200 kPa (abs) when restarting the power generation.

8. A power generation performance recovery method of a fuel cell in a fuel cell system, the power generation performance recovery method comprising:
stopping supply of an oxidant gas to the fuel cell; and after a voltage generated by the fuel cell is decreased to or below a predetermined first value and also temperature of the fuel cell is decreased to or below a predetermined second value, restarting the supply of the oxidant gas to the fuel cell and restarting power generation of the fuel cell, so as to produce water and thereby recover voltage of the fuel cell.

9. The power generation performance recovery method according to claim 8,
wherein the first value is a positive value that is not higher than 0.6 V.

10. The power generation performance recovery method according to claim 8,
wherein restarting the power generation of the fuel cell restarts such that an amount of water produced by reaction of the fuel cell after the restart of the power generation of the fuel cell is an amount corresponding to a relative humidity of not lower than 200% in a center of an oxidant gas flow path, in which the oxidant gas of the fuel cell flows.

11. The power generation performance recovery method according to claim 8,
wherein a time from the time when the voltage is decreased to or below a predetermined first value to the time when the controller restarts the supply of the oxidant gas is 10 minutes or longer.

12. The power generation performance recovery method according to claim 8,
wherein the second value is a value that is not lower than room temperature and not higher than 40° C.

13. The power generation performance recovery method according to claim 8,
wherein restarting the power generation of the fuel cell restarts with an electric current having a current density of not lower than 0.1 A/cm² and not higher than 0.2 A/cm².

14. The power generation performance recovery method according to claim 8,
wherein restarting the power generation controls back pressure of the oxidant gas to be not lower than 140 kPa (abs) and not higher than 200 kPa (abs).
